(19) United States
(12) Patent Application Publication
(10) Pub. No.: US 2026/0167359 A1
(43) Pub. Date: Jun. 18, 2026

(54) PHOTONIC PROPULSION SYSTEM

(71) Applicant: Spar Systems Inc., Montvale, NJ (US)

(72) Inventor: Gaurav Bazaz, Montvale, NJ (US)

(73) Assignee: Spar Systems Inc., Montvale, NJ (US)

(21) Appl. No.: 19/418,619

(22) Filed: Dec. 12, 2025

Related U.S. Application Data
(60) Provisional application No. 63/733,926, filed on Dec. 13, 2024.

(51) Int. Cl. B64G 1/40; B64G 1/24

(52) U.S. Cl. CPC B64G 1/409; B64G 1/244

(57) ABSTRACT

A photonic propulsion system for a spacecraft includes solid-state emitters mounted on a substrate that emit electromagnetic radiation. An optical collimation assembly receives the electromagnetic radiation and converts the electromagnetic radiation to a collimated photon beam. A pointing subsystem is configured to orient the collimated photon beam in a commanded direction. A power subsystem provides electrical power to the photon stream source to energize the solid-state emitters. A thermal management subsystem dissipates heat generated during operation of the solid-state emitters. A control subsystem receives a thrust command and regulates activation of the solid-state emitters using the regulated electrical power provided by the power subsystem and generates a thrust vector for the spacecraft using momentum carried by the collimated photon beam.

### CROSS-REFERENCE TO RELATED APPLICATION

This application claims the benefit under 35 U.S.C. § 119(e) of the filing date of U.S. Provisional Application No. 63/733,926, filed on Dec. 13, 2024, and entitled PHOTONIC SPACE PROPULSION SYSTEM, the content of which is incorporated herein by reference in its entirety.

### FIELD

The present disclosure relates to photonic propulsion systems. More particularly, the present disclosure relates to propellant-free propulsion systems that generate thrust or torque using directed electromagnetic radiation emitted from onboard solid-state photon sources (such as solid-state emitters).

### BACKGROUND

Spacecraft commonly depend on chemical propulsion or electric propulsion systems that require stored propellant mass. Propellant storage increases spacecraft cost, mass, risk, and operational limits. Once propellant is exhausted, the spacecraft loses maneuvering capability.

Prior photon-propulsion proposals fail to disclose practical mechanisms for emission, collimation, steering, powering, cooling, or controlling theoretical photon-based thrust devices in which momentum carried by photons produce thrust.

There exists a need for a solid-state, electrically powered, fully engineered, practical photonic propulsion system capable of generating thrust and torque for spacecraft attitude control, station-keeping, drag makeup, orbit adjustment, and long-duration missions.

### SUMMARY

The present system provides a photonic propulsion system configured to generate thrust or torque for a spacecraft using directed electromagnetic radiation emitted from onboard solid-state photon sources. The system operates without consumable propellant, enabling long-duration maneuverability limited only by electrical power availability. The system integrates solid-state emitter arrays, beam-shaping optics, pointing mechanisms, power electronics, thermal management structures, and control logic into a unified propulsion module suitable for spacecraft of various scales.

In some aspects, the techniques described herein relate to a photonic propulsion system for a spacecraft, including: a photon stream source including a plurality of solid-state emitters mounted on a substrate and configured to emit electromagnetic radiation in response to being activated; an optical collimation assembly positioned in optical alignment with the photon stream source and configured to receive the electromagnetic radiation from the solid-state emitters and further configured to convert at least a portion of the electromagnetic radiation to a collimated photon beam including a reduced spatial divergence relative to the emitted optical radiation; a pointing subsystem configured to orient the collimated photon beam in a commanded direction; a power subsystem configured to provide electrical power to the photon stream source to energize the solid-state emitters; a thermal management subsystem thermally coupled to the photon stream source and configured to dissipate heat generated during operation of the solid-state emitters and other heat generating components of the photonic propulsion system; a spacecraft avionics interface configured to enable communication between the photonic propulsion system and the spacecraft; and a control subsystem configured to: receive, from the spacecraft avionics interface, a thrust command; in response to receiving the thrust command, regulate activation of the solid-state emitters using the electrical power provided by the power subsystem; and regulate operation of the pointing subsystem to generate a thrust vector for the spacecraft using momentum carried by the collimated photon beam.

In some aspects, the techniques described herein relate to a method of generating thrust for a spacecraft using a photonic propulsion system, the method including: energizing, using electrical power provided by a power subsystem, a plurality of solid-state photon emitters of a photon stream source to emit electromagnetic radiation; collimating at least a portion of the emitted electromagnetic radiation using an optical collimation assembly to form a collimated photon beam having a reduced spatial divergence relative to the emitted electromagnetic radiation; orienting the collimated photon beam using a pointing subsystem in a commanded direction; controlling, by a control subsystem, in response to a thrust command received via a spacecraft avionics interface, activation of the solid-state emitters and operation of the pointing subsystem to generate a thrust vector for the spacecraft using momentum carried by the collimated photon beam; and establishing communication, by a spacecraft avionics interface, between the photonic propulsion system and the spacecraft.

In one aspect, the system includes a photon stream source comprising a plurality of emitters mounted on a substrate and driven through electrical interconnects. Divergent optical output from the emitters is shaped by an optical collimation assembly—such as a microlens array or a macro lens—to produce a directed photon beam. A pointing subsystem, which may include mechanical actuators or optical steering elements, orients the beam in a commanded direction. The resulting directed photon beam produces thrust approximately proportional to F=P/c, where F=thrust (Newtons), P=Power of the photon beam (watts) (or the directed optical power), and c=speed of light.

In another aspect, the system includes a power subsystem providing electrical energy to the emitters and a thermal management subsystem dissipating heat from the emitter substrate. A control subsystem receives thrust commands, computes beam orientation, and modulates emitter activation. The system may deliver continuous thrust, pulsed thrust, or burst-mode thrust, enabling precision attitude control, station-keeping, drag compensation, and trajectory adjustments. Implementations include single-module propulsion units and multi-module configurations that combine partial thrust vectors to generate a net thrust vector or rotational torque.

The disclosed architecture supports numerous variations, including different emitter types, optical assemblies, mechanical or optical pointing mechanisms, thermal pathways, electrical configurations, and control modes. The disclosure thus provides a broad technical foundation suitable for implementing and improving practical photonic propulsion systems across a wide range of spacecraft platforms.

### BRIEF DESCRIPTION OF THE DRAWINGS

The present disclosure is illustrated by way of example, and not by way of limitation, in the figures of the accompanying drawings.

FIG. 1 illustrates a spacecraft including a photonic space propulsion system having a photon stream source, an optical collimation assembly, and a pointing subsystem.

FIG. 2 illustrates a system-level block diagram of the photonic space propulsion system including the photon stream source, optical collimation assembly, pointing subsystem, power subsystem, thermal management subsystem, and control subsystem.

FIG. 3 illustrates an emitter array including emitters mounted to a substrate and interconnected by electrical interconnects in a photon stream source.

FIG. 4 illustrates an optical collimation assembly including lens substrate supporting microlenses.

FIG. 5 illustrates a mechanical pointing subsystem including a stepper motor driving a rotator arm coupled to the photon stream source.

FIG. 6 illustrates an optical beam-steering subsystem including mirror, mirror base, and MEMS actuators.

FIG. 7 illustrates a thermal management subsystem including heat spreader, coolant loops, and radiator.

FIGS. 8(a)-8(c) illustrate continuous thrust, pulsed thrust, and burst-mode thrust profiles over time.

FIG. 9 illustrates a control flow diagram including thrust request, beam computation, emitter activation, power check, thermal check, activation, feedback, adjustment, completion check, and stop.

FIG. 10(a) illustrates an implementation in which the emitters are mounted on a rectangular substrate.

FIG. 10(b) illustrates a circular emitter configuration in which emitters are distributed over a circular substrate.

FIG. 10(c) illustrates a polygonal substrate carrying multiple emitters.

FIG. 11 illustrates an implementation of an optical collimation system employing a macro lens to collimate divergent optical radiation emitted by a set of emitters mounted on a supporting substrate.

FIG. 12 illustrates an implementation of the mechanical mounting and electrical routing architecture used to affix a photon stream source to a spacecraft and supply it with power and control signals.

FIG. 13(a) illustrates an implementation in which electrical power is supplied primarily by a solar panels module.

FIG. 13(b) illustrates an implementation in which power is drawn from a battery module.

FIG. 13(c) illustrates a configuration using an energy storage module block, which may include supercapacitors, ultracapacitors, flywheels, rechargeable capacitive arrays, or hybrid storage elements combining battery-like and capacitor-like characteristics.

FIG. 13(d) illustrates a hybrid configuration combining a solar panels module 1300, a solar panels power conditioning module, an energy storage module, and the photon stream source.

FIG. 14. illustrates an implementation of a multi-module photonic propulsion configuration in which two independently steerable photon stream sources generate separate thrust vectors that combine to form a resultant thrust vector applied to the spacecraft.

FIG. 15 depicts a flowchart illustrating a method for generating thrust for a spacecraft using a photonic propulsion system.

### DETAILED DESCRIPTION

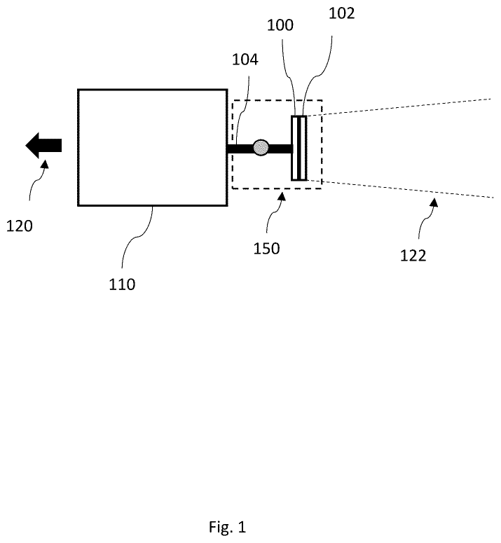

Aspects and implementations of the disclosure are directed to a photonic propulsion system for a spacecraft as described herein with respect to FIG. 1. The photonic propulsion system includes a photon stream source, an optical collimation assembly, a pointing subsystem, a power subsystem, a thermal management subsystem, a spacecraft avionics interface, and a control subsystem. The photon steam includes solid-state emitters mounted on a substrate and configured to emit electromagnetic radiation in response to being activated. The optical collimation assembly is positioned in optical alignment with the photon stream source and configured to receive the electromagnetic radiation from the solid-state emitters and further configured to convert at least a portion of the electromagnetic radiation to a collimated photon beam including a reduced spatial divergence relative to the emitted optical radiation. The pointing subsystem is configured to orient the collimated photon beam in a commanded direction. The power subsystem is configured to provide electrical power to the photon stream source to energize the solid-state emitters. The thermal management subsystem is thermally coupled to the photon stream source and configured to dissipate heat generated during operation of the solid-state emitters and other heat generating components of the photonic propulsion system. The spacecraft avionics interface is configured to enable communication between the photonic propulsion system and the spacecraft. The control subsystem is configured to: receive, from the spacecraft avionics interface, a thrust command; in response to receiving the thrust command, regulate activation of the solid-state emitters using the electrical power provided by the power subsystem; and regulate operation of the pointing subsystem to generate a thrust vector for the spacecraft using momentum carried by the collimated photon beam.

FIG. 1 illustrates a spacecraft 110 including a photonic space propulsion system 150 having a photon stream source 100, an optical collimation assembly 102, and a pointing subsystem 104. A directed photon beam 122 exits the optical collimation assembly 102 and produces a thrust vector 120 opposite the direction of emission. The spacecraft can be any kind of spacecraft such as satellites, CubeSats, nanosats or other spacecrafts. The optical collimation assembly 102 is positioned in optical alignment with the photon stream source 100.

The photon stream source 100 generates a directed emission of electromagnetic radiation in the form of a photon beam 122. This radiation may be in the visible or invisible spectra (e.g., infrared or ultraviolet). The emission of this photon beam results in a thrust (momentum change) in the spacecraft 110, due to the laws of conservation of momentum. The magnitude of the thrust generated is given as

$$F = P / c where , F = thrust ( Newtons ) , \\ P = Power of the photon beam ( watts ) , and c = speed of light .$$

As conveyed by the above equation, the magnitude of thrust is quite low for a given amount of power, due to the large magnitude of c (speed of light). Nevertheless, in a space environment with near-zero drag, this thrust can accumulate over time to very large delta-v (change in velocity). Additionally, many space maneuvers require very small thrusts, in the micro-newton and milli-newton range, which the radiation emission can accomplish with practical power constraints.

The radiation emission can be generated using LEDs, laser diodes, vertical-cavity surface-emitting lasers (VCSELs), or other solid-state radiation sources. Additionally, to maximize the resultant thrust, the beam should be focused as much as possible, so that the spatial dispersion of the photon beam is minimized. This is done by using lenses, in any of various possible configurations, and passing the photon beam through this optical collimation assembly 102. The direction of thrust generated by thrust vector 120 is the opposite (i.e., 180 degrees) to the direction of the directed photon beam 122, per the law of momentum conservation.

A pointing subsystem 104 connects the photon stream source 100 to the spacecraft 110 body. This pointing subsystem can point the directed photon beam 122 in the desired direction so as to control the direction of the thrust produced. The pointing subsystem may consist of various subparts and can be implemented in one of various implementations, such as 3-axis gimbals or 6-degree of freedom arms.

In some implementations, the control subsystem is configured to execute closed-loop attitude or trajectory correction. In some implementations, the modules are positioned asymmetrically around the spacecraft body to generate torque.

In some implementations, at least one module may be mounted on a rotatable arm configured to vary the thrust vector relative to the spacecraft's center of mass.

In some implementations, the control system may be configured to differentially activate the modules to generate roll, pitch, or yaw rotation.

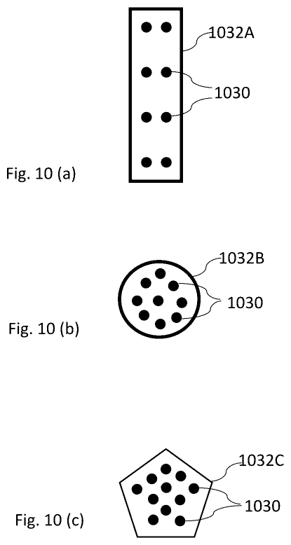

In some implementations, the solid-state emitters comprise light-emitting diodes (LEDs), laser diodes, vertical-cavity surface-emitting lasers (VCSELs), or combinations thereof. In some implementations, the emitters may arranged in a planar, circular, polygonal, curved, or faceted array (see FIGS. 10(a)-10(c) below).

In some implementations, the optical collimation assembly includes a microlens array or a macro lens. In some implementations, the optical collimation assembly includes multiple optical elements arranged to reduce beam divergence.

In some implementations, the pointing subsystem includes a mechanical actuator selected including stepper motors, servomotors, gimbals, and rotator arms. In some implementations, the pointing subsystem includes an optical steering mechanism comprising a mirror actuated by micro-electromechanical (MEMS) actuators (described herein).

In some implementations, the pointing subsystem provides one or more degrees of rotational freedom. In some implementations, the thermal management subsystem includes a heat spreader thermally coupled to the emitters.

In some implementations, coolant loops are configured to remove heat from the heat spreader.

In some implementations a radiator dissipates heat into space. In an implementation, the power subsystem includes a solar-derived power input and associated power conditioning circuitry.

In an implementation, the power subsystem includes a battery or energy storage device configured to deliver continuous, pulsed, or burst power. In an implementation, the power subsystem includes a capacitor-based storage element configured to supply high-power bursts to the emitters. In an implementation, the control subsystem is configured to generate continuous thrust, pulsed thrust, burst thrust, or combinations thereof.

In an implementation, the control subsystem uses feedback from spacecraft avionics to adjust emitter activation or beam orientation.

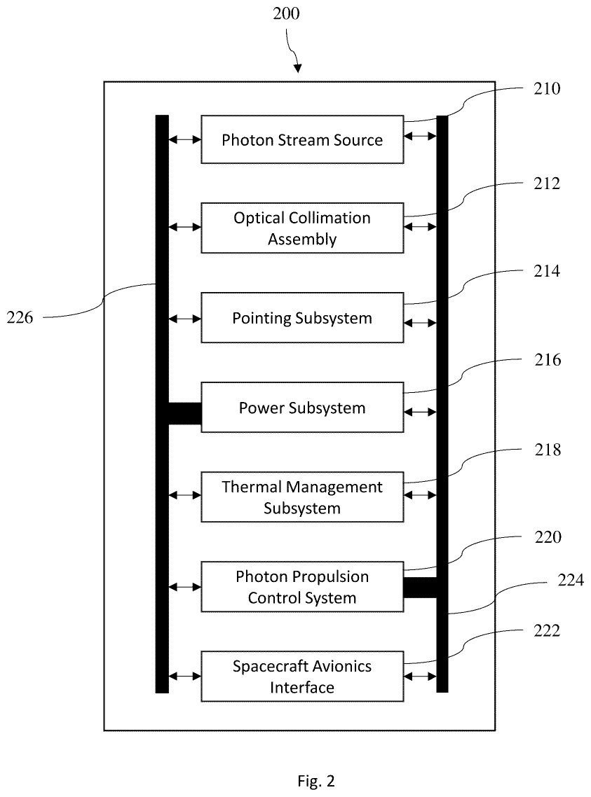

FIG. 2 illustrates a system-level block diagram of the photonic space propulsion system 200 including a photon stream source 210, optical collimation assembly 212, pointing subsystem 214, power subsystem 216, thermal management subsystem 218, photonic propulsion control system 220 and spacecraft avionics interface 222. These modules are implemented by the photonic space propulsion system 200. Additional modules may be included in other implementations. The modules may correspond bidirectionally or unidirectionally with one another using a control system bus 224 and/or a power subsystem bus 226.

The photon stream source 210 is the module that generates the photon beam which produces thrust. The optical collimation assembly 212 is the module that focuses the photon beam from photon stream source 210 to minimize dispersion and maximize conversion of the photon beam momentum into thrust. In some implementations, this may be excluded, however, it will result in a lower performance system.

The pointing subsystem 214 is the module that allows controlling the direction of emission of the photon beam, thereby controlling the thrust direction. Again, in some implementations this subsystem may be excluded, however, such an implementation will be substantially less effective as the thrust direction is fixed relative to the spacecraft body.

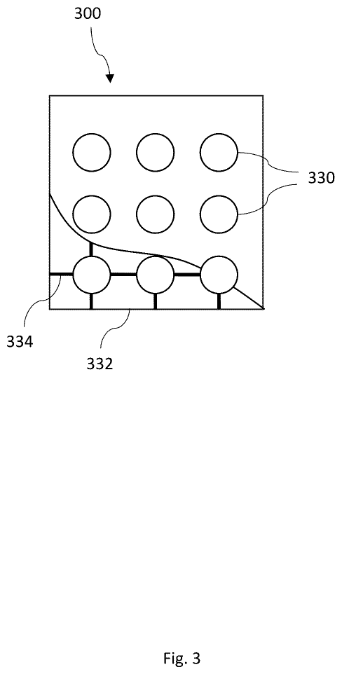

The power subsystem 216 is the module that delivers power to the photon stream source 210 for producing the photon beam. Additionally, it may also deliver power to various other subsystems of the photonic space propulsion system 200, as required. In some implementations, the power subsystem receives electrical power from a power source of the spacecraft and provides regulated electrical power to the photon stream source 210 for energizing the solid-state emitters 330 (described herein with respect to FIG. 3). The power subsystem may include its own power generation or energy storage component, in addition to power equipment such as converters, conditioners, capacitors, sensors etc. In some implementations, the power is supplied externally by the spacecraft or another vehicle, but the power subsystem 216 of photonic space propulsion system 200 interfaces with this external energy source to delivery power to the photon stream source 210 and other subsystems.

The thermal management subsystem 218 is the module that manages the heat generated from the operation of the photonic space propulsion system 200. Heat is generated substantially in the photon stream source 210, as part of the electric power to radiation conversion process. Additional heat may be generated elsewhere in the system including in the power subsystem. This heat is to be removed and ejected from the photonic space propulsion system 200 in order to enable normal operation and prevent overheating and thermally driven failures of the photonic space propulsion system 200. The thermal management subsystem may include heat spreaders, coolant loops, pumps, radiators and other components to enable transfer of heat from the components of the system to space. Some aspects of thermal management may be offloaded to or shared with the underlying spacecraft in some implementations.

The photonic propulsion control system 220 includes computational resources including the hardware and software to control the operation of all subsystems and components of the photonic space propulsion system 200.

The spacecraft avionics interface 222 is the module that controls communication between the photonic space propulsion system 200 and the underlying spacecraft on which it is mounted. This enables GNC (guidance, navigation and control) communication between the spacecraft and the photonic space propulsion system.

The control subsystem receives a thrust command from a spacecraft avionics interface 222. In response to receiving the thrust command, the control subsystem regulates activation of the solid-state emitters 330 and operation of the pointing subsystem to generate a thrust vector using momentum carried by the collimated photon beam.

In an implementation, the control subsystem uses the electrical power provided by the power subsystem 216. The control subsystem is further configured to regulate the operation of the pointing subsystem, including mechanical and optical steering mechanisms, to orient the collimated photon beam to generate a commanded thrust vector for the spacecraft using momentum carried by the collimated photon beam.

The spacecraft avionics interface 222 may also transmit status, telemetry, or health-monitoring data between the photonic propulsion system and the spacecraft.

FIG. 3 illustrates an implementation of an emitter array including emitters mounted to a substrate and interconnected by electrical interconnects in a photon stream source 300. In this implementation, solid-state emitters 330 are mounted on a supporting substrate 332, which provides structural, mechanical, thermal, and electrical support for the emitters. The solid-state emitters 330 may include, without limitation, light-emitting diodes (LEDs), laser diodes, vertical-cavity surface-emitting lasers (VCSELs), or other semiconductor radiation sources capable of producing electromagnetic radiation in visible, infrared, or ultraviolet wavelengths.

In an implementation, in response to the solid-state emitters 330 receiving regulated electrical power from the power subsystem, the solid-state emitters 330 are energized and emit electromagnetic radiation from the supporting substrate 332.

The supporting substrate 332 may include a metal-core printed circuit board (MC-PCB), a ceramic substrate, a composite thermal substrate, or any multilayer board incorporating conductive thermal vias. The substrate provides both the physical mounting surface for the solid-state emitters 330 and the thermal conduction path through which heat generated by emitter operation is transported toward heat spreaders or radiative elements.

Electrical interconnects 334 are provided on or within the supporting substrate 332 to deliver electrical power and control signals to each of the solid-state emitters 330. The interconnects 334 may include copper traces, multilayer routing structures, plated vias, flexible ribbon conductors, or other interconnects. In some implementations, interconnects 334 are arranged in addressable rows and columns to permit independent or group-based activation of selected emitters. In other implementations, interconnects 334 may be arranged differently.

The solid-state emitters 330 may be arranged in a regular grid, a hexagonal packing pattern, or any regular or irregular tiling suitable for the available mounting area. The geometry shown in FIG. 3 represents a planar rectilinear array for simplicity, but the system is not limited to planar arrays; curved, angled, faceted, or other emitter surfaces may be used to achieve particular optical or structural performance.

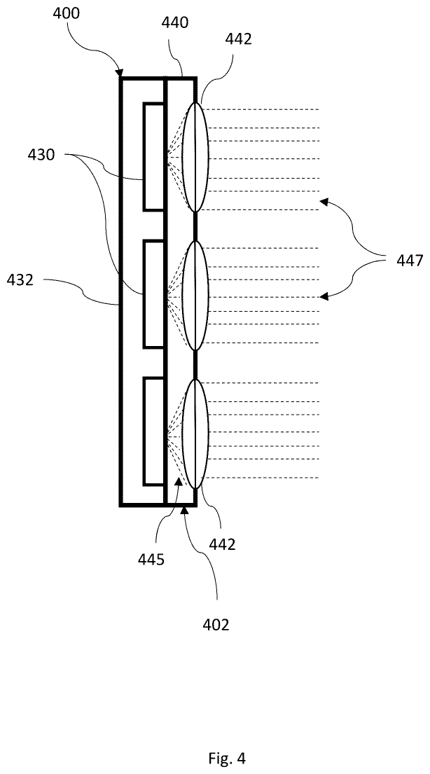

Each of the solid-state emitters 330 generates divergent rays when energized. These divergent rays propagate away from the supporting substrate 332 and are subsequently collected and shaped by the optical collimation assembly 402 (described in FIG. 4). In some implementations, the spacing and arrangement of the solid-state emitters 330 are chosen to match the pitch of corresponding microlenses 442 in a microlens array (described in FIG. 4) to maximize optical coupling efficiency.

The emitter array of FIG. 3 forms the primary photon-generating element of the photonic space propulsion system. The aggregate optical power emitted by the array determines the available thrust according to approximately F=P/c, where P is the total directed optical power after collimation. Accordingly, the number of emitters, their optical efficiency, and the electrical power delivered through interconnects 334 directly influence achievable thrust.

In some implementations, sensors integrated on or beneath the supporting substrate 332 monitor temperature, electrical loading, or emitter health status. These sensor readings may be routed through electrical interconnects 334 to a control subsystem, enabling closed-loop thermal regulation or selective emitter throttling to maintain safe operation.

FIG. 4 illustrates an optical collimation assembly 402 including lens substrate supporting microlenses. The optical collimation assembly 402 is coupled with a stacked arrangement of emitter modules to form a directed photon beam. In this implementation, a photon stream source 400 supports multiple vertically spaced emitter modules, including a first emitter included in emitter modules 430 and the supporting substrate 432. Each emitter module may include one or more solid-state radiation sources—such as LEDs, laser diodes, or VCSELs—configured to emit optical radiation during operation.

The emitter modules 430 emit divergent rays 445, shown in FIG. 4 as dashed lines radiating outward from each emitter region. The divergence angle of the rays is determined by the characteristics of the solid-state emitters and may range from tens of degrees to over one hundred degrees depending on wavelength and emitter geometry.

To convert the divergent rays 445 into a useful propulsion beam, the optical collimation assembly 402 includes a lens substrate 440 carrying a corresponding set of microlenses 442. Each microlens 442 is positioned in optical alignment with a respective emitter module so that the majority of the divergent rays 445 emitted from the underlying module pass through the microlens.

The microlenses 442 act to refract and redirect the incoming divergent rays 445 into a more narrowly confined group of rays, forming a collimated output beam 447. This collimated beam improves the thrust efficiency of the propulsion system by increasing the proportion of photon momentum directed along the intended thrust axis.

The lens substrate 440 may be fabricated from glass, fused silica, optical polymer, or another suitable optical material. In some implementations, the substrate 440 is a monolithic structure containing all microlenses 442, whereas in other implementations it may be formed as an array of individually mounted microlens elements.

The spacing between the emitter modules 430 and the lens substrate 440 is selected such that the focal planes of the microlenses 442 coincide with the effective radiating surfaces of the emitters. This alignment optimizes the efficiency of the conversion from divergent rays 445 into the collimated beam 447. The figure illustrates three emitter-lens pairs, but any number of stacked or tiled emitter modules may be employed, and the optical collimation assembly 402 may contain corresponding microlens elements for each.

In operation, the collimated output beam 447 formed by the optical collimation assembly 402 becomes the directed photon beam used by the spacecraft to generate thrust. The momentum carried by the collimated photons produces a reaction force according to F=P/c, where P is the optical power emitted in the direction of the beam and cis the speed of light. Improved collimation achieved by microlenses 442 increases the proportion of optical power contributing to thrust, thereby enhancing system performance.

The optical collimation assembly 402 may convert the electromagnetic radiation emitted by the photon stream source 400 into a collimated photon beam having a reduced spatial divergence relative to the emitted optical radiation.

Although FIG. 4 illustrates vertically aligned emitter modules 430 with corresponding vertically aligned microlenses 442, alternate geometries may be used, including two-dimensional planar arrays, circular arrays, polygonal arrays, or curved emitter surfaces, with corresponding optical collimation elements adapted to each geometry.

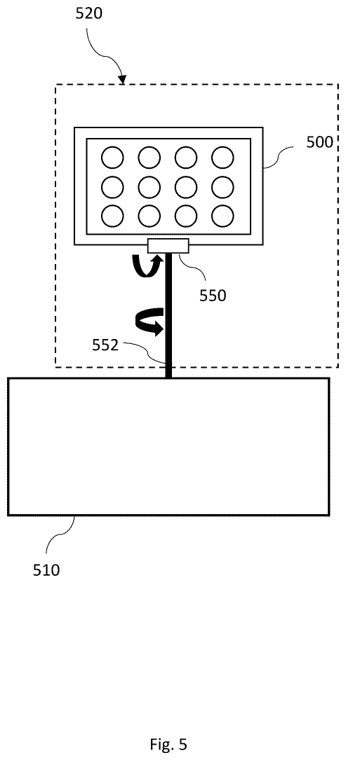

FIG. 5 illustrates an implementation of a photonic space propulsion system 520 mounted to a spacecraft 510 and configured to mechanically orient a photon stream source 500. The photonic space propulsion system 520 includes structural and actuation elements that allow the photon stream source 500 to rotate about one or more axes for thrust vector control.

The photon stream source 500 is mechanically coupled to a rotator arm 552, and a stepper motor 550. The combination allows the photon stream source 500 to be pointed in almost every direction, by turning the rotator around its axis and spinning the stepper motor about its axis.

The stepper motor 550 may be a uniaxial or multiaxial rotational actuator, and may be mounted within, adjacent to, or integral to the housing of the photonic space propulsion system 520. When energized, the stepper motor 550 rotates the photon stream source 500 in discrete increments or continuous motion, depending on command input from the spacecraft's control subsystem.

Rotation applied through the rotator arm 552 adjusts the pointing direction of the photon stream source 500, thereby redirecting the emitted photon beam and altering the resulting thrust vector. This configuration enables the spacecraft 510 to generate thrust or torque in a controlled direction without reorienting the spacecraft body itself.

The FIG. 5 implementation presents a single-axis rotation mechanism for clarity; however, the photonic space propulsion system 520 may incorporate additional degrees of freedom by combining multiple stepper motors 550, stacked rotation joints, or hybrid mechanical-optical steering architectures.

Electrical power and control signals may be routed through or around the rotator arm 552 to the photon stream source 500. Structural attachment between the photonic space propulsion system 520 and the spacecraft 510 may be achieved using elements such as brackets, fasteners, or integrated mounting surfaces (not depicted).

The pointing mechanism of FIG. 5 enables fine thrust vector control, allowing the propulsion system to produce translational thrust or rotational torque depending on the commanded orientation of the photon stream source 500.

The pointing subsystem, including the stepper motor 550 and rotator arm 552, may be operated under command of the control subsystem to orient the collimated photon beam in a commanded direction.

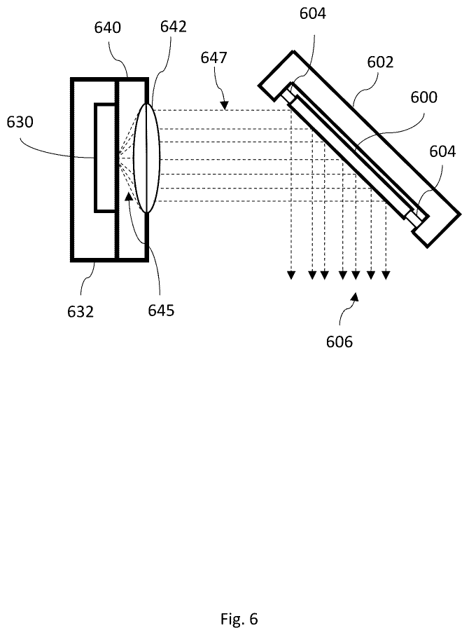

FIG. 6 illustrates an implementation of an optical beam-steering subsystem that redirects a collimated photon beam using a mirror actuated by micro-electromechanical (MEMS) elements. The subsystem receives collimated light from an upstream optical collimation assembly and uses a steerable mirror to change the outgoing beam direction without requiring mechanical rotation of the entire propulsion module.

As shown in FIG. 6, one of the emitters 630 is mounted on a supporting substrate 632 and generate divergent rays 645 during operation. These rays propagate through a lens substrate 640 that supports one or more microlenses 642.

Each microlens 642 receives a portion of the divergent rays 645 and refracts them to form a collimated beam 647. This collimated beam is directed along an initial optical axis extending outward from the lens substrate 640. The emitter-microlens pairing shown in FIG. 6 represents one beam-forming channel, though additional channels or arrays may be employed.

The collimated beam 647 is incident upon a mirror 600 positioned downstream from the microlenses 642. The mirror 600 is mechanically supported by a mirror base 602, which provides structural rigidity and defines the hinge or pivot constraints of the reflective element.

The mirror 600 is actuated by one or more MEMS actuators 604, which may include electrostatic, thermal-bimorph, piezoelectric, or electromagnetic micro-actuators. The MEMS actuators 604 impart small, high-precision angular displacements to the mirror 600 about one or more axes.

As the mirror 600 changes orientation under command of the MEMS actuators 604, the incident collimated beam 647 is redirected into a set of reflected beams 606, shown in FIG. 6 as dashed downward-propagating lines. The angular direction of the set of reflected beams 606 corresponds to the instantaneous orientation of the mirror and can be varied continuously or in discrete steps.

The MEMS actuators 604 receive control signals from the control subsystem to adjust the orientation of mirror 600 and thereby orient the collimated photon beam in the commanded direction.

The beam-steering assembly of FIG. 6 enables redirection of the photon output without rotating the supporting substrate 632, the emitters 630, the lens substrate 640, or the surrounding photonic propulsion system. This permits fast, fine-resolution pointing adjustments suitable for closed-loop attitude control, micro-impulse thrusting, and high-precision spacecraft orientation maneuvers.

In some implementations, multiple mirrors 600 or cascaded MEMS steering stages may be used to produce multi-axis beam deflection, expanded angular range, or dynamic beam shaping. The configuration shown in FIG. 6 illustrates a single-stage mirror steering mechanism for clarity, but the system encompasses any combination of mechanical, MEMS-based, or optical beam-steering architectures.

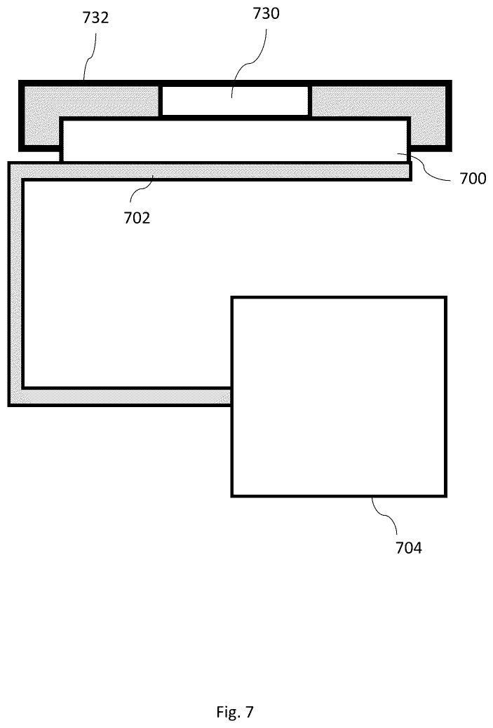

FIG. 7 illustrates a thermal management subsystem including heat spreader, coolant loops, and radiator. The thermal management subsystem is configured to remove heat generated by emitters 730 during operation of the photonic propulsion system. Because solid-state emitters produce both optical radiation and significant waste heat, effective thermal conduction and rejection are used for maintaining stable emitter performance and preventing thermal overload.

As shown in FIG. 7, the emitters 730 are mounted on a supporting substrate 732, which may be formed from a thermally conductive material such as aluminum nitride, copper-clad ceramic, a metal-core PCB, or other high-thermal-conductivity composite. The supporting substrate 732 provides mechanical support for the emitters 730 and serves as the initial thermal interface. The thermal management subsystem is thermally coupled to the photon stream source and configured to dissipate heat generated during operation of the solid-state emitters 730.

Positioned immediately beneath the supporting substrate 732 is a heat spreader 700, which distributes heat laterally to avoid localized thermal hotspots beneath individual emitters. The heat spreader 700 may be fabricated from copper, aluminum, graphite composite, vapor chamber plates, or other high-conductivity materials. In some implementations, the heat spreader 700 incorporates internal wick structures or phase-change regions to enhance thermal equalization.

The heat spreader 700 is thermally coupled to one or more coolant loops 702, shown in FIG. 7 as a continuous fluid pathway extending from the heat spreader toward a radiator 704. Coolant loops 702 may include embedded microchannels, hollow pipes, serpentine channels, or additive-manufactured coolant passages designed to transfer heat from the heat spreader 700 to the radiator 704.

A working fluid flows through coolant loops 702 to transport heat away from the emitters 730. Suitable working fluids may include water-based coolants, alcohol-based mixtures, dielectric fluids, or refrigerants compatible with microgravity operation. In alternative implementations, the coolant loops 702 may function as heat pipes or vapor chambers relying on phase change rather than pumped circulation.

The coolant loops 702 terminate at a radiator 704, which dissipates the transported thermal energy into space via infrared emission. The radiator 704 may be planar, finned, folded, deployable, or integrated into the spacecraft body. Radiator 704 may include high-emissivity surface coatings or multilayer optical coatings to maximize radiative heat rejection.

During operation, waste heat generated by the emitters 730 is conducted through the supporting substrate 732 into the heat spreader 700, distributed uniformly across its lateral extent, transferred into the coolant loops 702, and finally rejected by the radiator 704. This hierarchical thermal pathway stabilizes the emitter operating temperature, ensuring reliable optical output and protecting the photon stream source from overheating.

As described above, the thermal management subsystem thermally couples to the photon stream source and configured to dissipate heat generated during operation of the solid-state emitters and other heat generating components of the photonic propulsion system. The other heat generating components include control electronics, power subsystem, wiring, and/or other electronic and/or electrical components.

Although FIG. 7 illustrates a single heat spreader 700, a single coolant loop 702, and a single radiator 704 for clarity, multiple parallel paths, redundant circuits, or deployable radiator surfaces may be used to scale thermal performance for higher optical power levels.

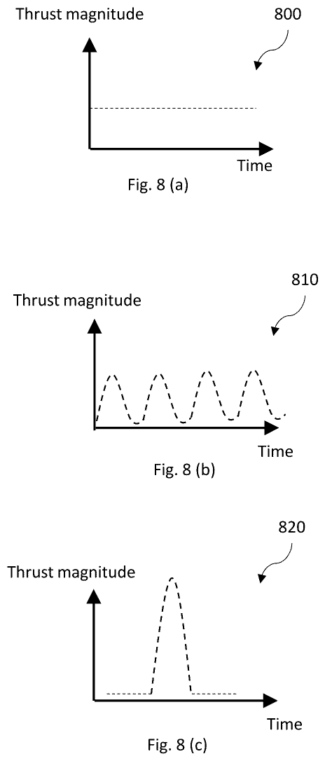

FIGS. 8(a)-8(c) illustrate representative thrust output profiles that may be generated by the photonic propulsion system during operation. These profiles demonstrate how the control subsystem may modulate the activation of the photon stream source to achieve different thrust behaviors depending on mission requirements such as station-keeping, fine attitude correction, momentum dumping, or rapid impulse generation.

FIG. 8(a) depicts a steady thrust profile 800, in which the thrust magnitude is held approximately constant over time. In this mode, the emitters operate continuously at a fixed power level, and the resulting directed photon beam produces a stable reaction force. Steady thrust is useful for long-duration orbital corrections, drag compensation, continuous solar-pressure counteraction, and gradual trajectory shaping.

FIG. 8(b) illustrates a pulsing thrust profile 810, represented by a periodic, oscillating thrust magnitude over time. This mode is achieved by activating the emitters intermittently at a controlled duty cycle using a duty cycle computed by the control subsystem. Pulsed operation may reduce thermal loading, conserve electrical power, and produce precise micro-impulse bits suitable for fine attitude control or momentum management. The frequency, amplitude, and duty cycle of pulses may be dynamically adjusted by the control subsystem based on sensor feedback.

FIG. 8(c) shows a burst thrust profile 820, in which the system produces a short, high-magnitude thrust pulse followed by a return to low or zero thrust. Burst thrust is generated by briefly driving the emitters at elevated power levels—potentially using stored energy from capacitors or other buffer components—to generate a rapid, high-intensity impulse. Such bursts may be used for rapid pointing adjustments, disturbance rejection, or collision avoidance maneuvers.

Although FIGS. 8(a)-8(c) illustrate specific example profiles, the photonic propulsion system may produce any arbitrary temporal thrust profile through modulated emitter activation, including asymmetric pulses, shaped thrust curves, or combined sequences of steady, pulsed, and burst modes. These examples are therefore illustrative and not limiting.

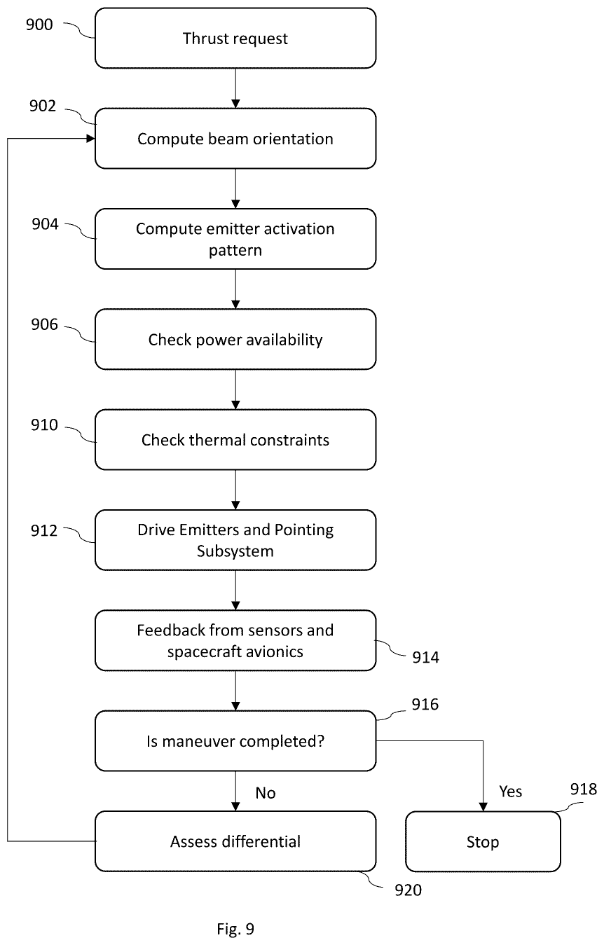

FIG. 9 illustrates a control flow diagram including thrust request, beam computation, emitter activation, power check, thermal check, activation, feedback, adjustment, completion check, and stop. The process begins at block 900, in which the control subsystem receives a thrust request. The thrust request may originate from the spacecraft's guidance, navigation, and control (GNC) system, from on-board mission planning software, or from ground-based command uplinks.

At block 902, the system performs beam orientation computation. This step determines the commanded direction for the photon beam based on the required change in spacecraft attitude or trajectory. The computation may incorporate spacecraft orientation data, inertial sensing, orbital parameters, or mission profile instructions.

At block 904, the control subsystem computes an emitter activation pattern, determining which emitters should be energized and with what drive levels or timing sequence. The emitter activation pattern may include continuous output, pulsed output, burst-mode output, or spatially selective activation of specific emitters to achieve differential thrust or fine optical alignment.

At block 906, the control system performs a power availability check. This includes verifying that adequate electrical power is available from the spacecraft's power subsystem, confirming bus voltage and current margins, and ensuring that energy reserves (e.g., batteries or capacitors) are adequate for the requested thrust mode.

At block 910, the system executes a thermal constraint check. This ensures that the emitters, substrates, heat spreaders, coolant loops, and radiators are within safe operating temperatures. Thermal models or real-time sensor data may be used to determine whether activation patterns need to be modified to protect the hardware.

Upon satisfying power and thermal requirements, the system proceeds to block 912, where it drives the emitters and pointing subsystem. In this step, electrical power is delivered to the emitters according to the computed activation pattern, and the pointing subsystem (which may include mechanical actuators or optical steering elements) aligns the photon beam in the commanded direction.

At block 914, the system receives feedback from sensors and spacecraft avionics, which may include inertial measurement units, star trackers, sun sensors, gyroscopes, reaction wheel telemetry, thermal sensors, or embedded photodiodes. This feedback provides real-time validation of thrust output, beam alignment, and system health.

Block 916 evaluates whether the maneuver is completed. The control subsystem compares real-time attitude or trajectory data against the desired end state. If the maneuver has been achieved, the process proceeds to block 918, where the system issues a stop command to deactivate emitters or return them to idle power.

If the maneuver is not complete, the system proceeds to block 920, where it assesses the differentials between required maneuver and maneuver completed so far. This may include modifying the activation pattern, changing pointing angles, altering duty cycle or pulse frequency, or adjusting thermal throttling parameters. After adjustments, control returns to block 902 for continued execution.

The control loop illustrated in FIG. 9 may operate at fixed or adaptive update rates, may be implemented in hardware, firmware, or software, and may be distributed across multiple control processors. The flow of FIG. 9 is illustrative and non-limiting; additional diagnostic, fault-management, or optimization steps may be incorporated.

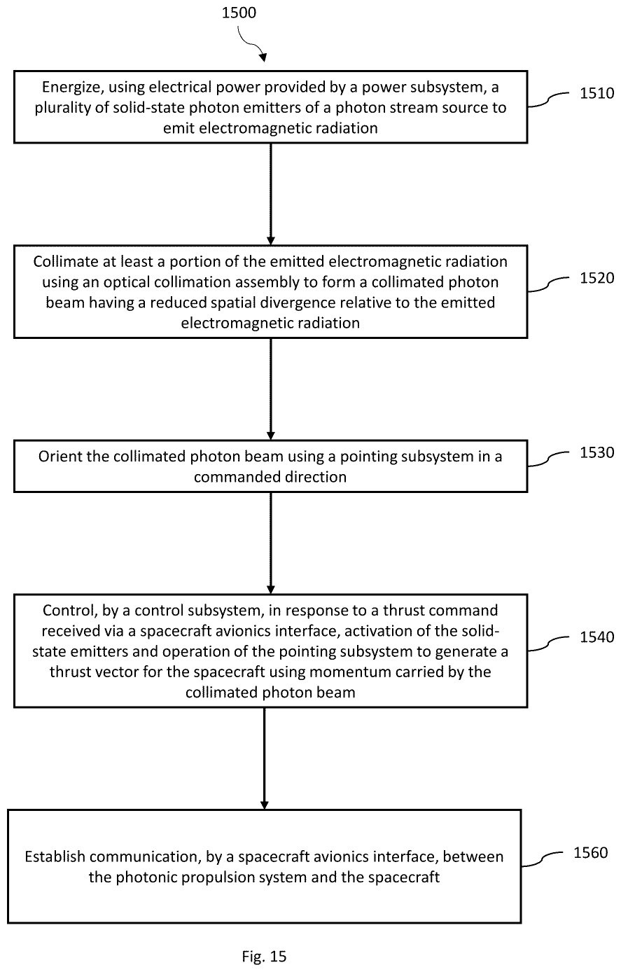

The control flow of FIG. 9 includes similar implementations as the method steps illustrated in FIG. 15 described below.

FIGS. 10(a)-10(c) illustrate representative examples of alternative emitter array geometries that may be employed in the photon stream source. These configurations demonstrate that the physical arrangement of emitters 1030 on substrates 1032A, 1032B, and 1032C, may vary depending on spacecraft geometry, available mounting area, beam-forming requirements, thermal management considerations, or manufacturability constraints.

FIG. 10(a) illustrates an implementation in which the emitters 1030 are mounted on a rectangular substrate 1032A. The emitters 1030 are arranged in one or more vertical columns or horizontal rows, forming a linear or grid-like pattern. This configuration is well suited for narrow installation spaces, stacked emitter modules, or propulsion systems designed to scale in one dimension.

The rectangular substrate 1032A may be elongated to support additional emitters 1030, allowing increased optical output power. This geometry can also be readily integrated with linear heat spreaders, elongated microchannel cooling structures, or modular beam-shaping optics.

FIG. 10(b) illustrates a circular emitter configuration in which emitters 1030 are distributed over a circular substrate 1032B. Emitters may be arranged in concentric rings, spiral patterns, or radial distributions. This geometry is advantageous when the propulsion system requires rotational symmetry or when optical elements such as circular macro lenses or axially symmetric collimators are used.

Circular arrangements can also facilitate uniform thermal spreading and simplify rotationally symmetric mounting to gimbals, pointing stages, or multi-module propulsion assemblies.

FIG. 10(c) illustrates a polygonal substrate 1032C, such as a pentagonal or hexagonal shape, carrying multiple emitters 1030. Polygonal substrates may be used to tile multiple photon stream sources together on a spacecraft surface or to match faceted spacecraft geometries such as multi-panel satellite buses.

Emitters 1030 may be positioned at the vertices, edges, or face centers of the polygon, depending on desired beam uniformity or coupling efficiency to downstream optical elements. Faceted geometries also support optical architectures in which each facet directs light toward a different orientation, enabling inherent multi-directional thrust capability.

The emitter arrangements shown in FIGS. 10(a)-10(c) are representative only. These implementations encompass any two-dimensional or three-dimensional arrangement of emitters 1030 mounted to a substrate 1032A, 1032B, and 1032C, including rectangular, circular, polygonal, curved, conformal, or irregular geometries.

The geometries illustrated are not limiting and may be adapted to meet power, thermal, structural, or optical requirements of different spacecraft platforms.

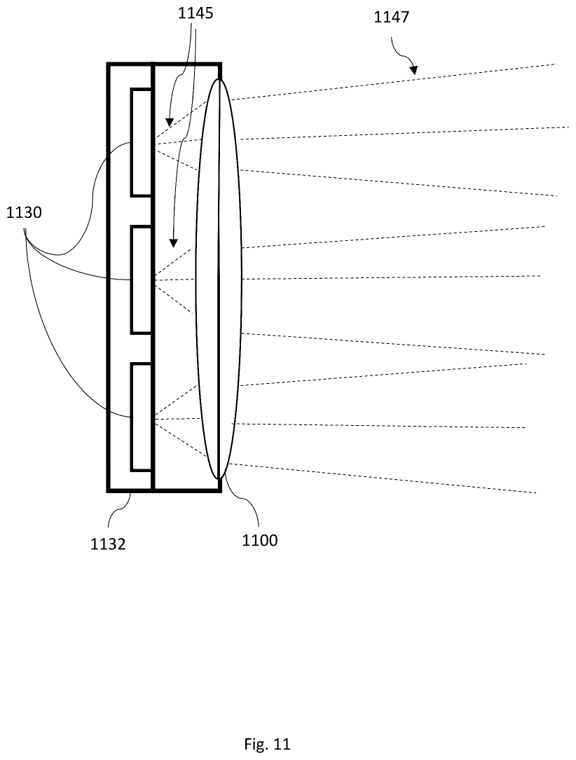

FIG. 11 illustrates an implementation of an optical collimation system employing a macro lens 1100 to collimate divergent optical radiation emitted by a set of emitters 1130 mounted on a supporting substrate 1132. This configuration represents a single-aperture, large-diameter optical approach to beam shaping, suitable for applications requiring improved collimation efficiency, longer-range photon propagation, or higher thrust performance.

As shown in FIG. 11, the emitters 1130 are mounted to a thermally and mechanically supporting substrate 1132. The emitters 1130 generate divergent rays 1145 when energized. These rays spread outward across a broad angular range defined by the emitter's native emission pattern.

The divergent rays 1145 are incident upon a macro lens 1100, which may be a single thick lens, a plano-convex or biconvex lens, a Fresnel-type lens, or another refractive optical structure capable of collecting a wide field of input rays. The macro lens 1100 is aligned such that its optical axis is normal to the emitter plane of the supporting substrate 1132.

As the divergent rays 1145 pass through the macro lens 1100, they are refracted so as to exit the lens as a collimated beam 1147. FIG. 11 illustrates this transition by showing the rays exiting the lens in substantially parallel trajectories. This collimation improves the propulsion efficiency of the photonic propulsion system by increasing the proportion of photon momentum directed along the intended thrust axis.

The macro lens 1100 may be fabricated from glass, fused silica, optical polymers, or radiation-hard materials suitable for space environments. Lens diameter, curvature, and focal length may be selected based on desired beam divergence, emitter aperture size, available standoff distance, and system power levels.

The spacing between the emitters 1130 and the macro lens 1100 is selected to place the emitters approximately at or near the focal plane of the macro lens 1100, producing optimal collimation for the divergent rays 1145. In some implementations, the supporting substrate 1132 may incorporate spacers, shims, or adjustable mounts to maintain accurate optical alignment during manufacturing or thermal cycling.

Although FIG. 11 depicts a single macro lens 1100 and a planar emitter supporting substrate 1132, the configuration is not limited to these geometries. Multiple macro lenses may be tiled, nested, or used in combination with microlens arrays. Curved emitter surfaces or lens assemblies may also be employed to achieve tailored beam profiles or multi-directional collimation.

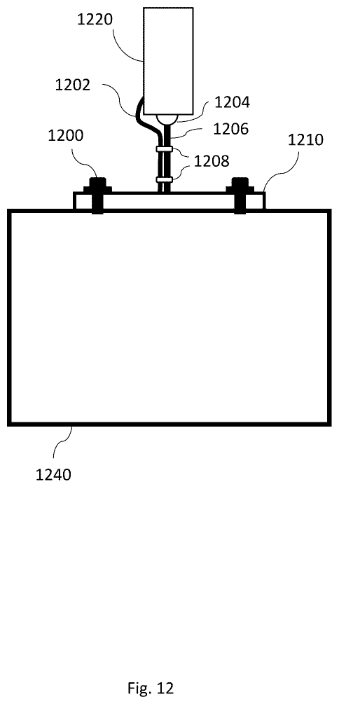

FIG. 12 illustrates an implementation of the mechanical mounting and electrical routing architecture used to affix a photon stream source 1220 to a spacecraft 1240 and supply it with power and control signals. The configuration shown provides a robust, modular interface that enables mechanical support, actuation, and electrical connectivity for the photonic propulsion system.

As shown in FIG. 12, the photon stream source 1220 is mechanically supported by a rotator arm 1206, and a stepper motor 1204. The rotator arm 1206 transfers rotational motion and the stepper motor 1204 transfers tilting motion to the photon stream source 1220, enabling controlled orientation of the emitted photon beam for thrust vectoring.

The stepper motor 1204 is mounted adjacent to or integrated within the support assembly and provides discrete or continuous rotational actuation. The rotational output shaft of the stepper motor 1204 is coupled to the positioning arm 1206, allowing the photon stream source 1220 to be oriented at commanded angles relative to the body of the spacecraft 1240.

The mechanical assembly is secured to the spacecraft 1240 using one or more mounting brackets 1210. The mounting brackets 1210 provide a stable load-bearing interface and may be constructed from aluminum, titanium, composite materials, or other aerospace-grade structures. The mounting brackets 1210 are affixed to the spacecraft surface using fasteners 1200, which may include bolts, screws, rivets, or captive hardware designed for vibration and thermal cycling tolerance.

Electrical power for the photon stream source 1220 is delivered through a power wire 1202, which may be a shielded conductor or multi-conductor cable routed from the spacecraft's power distribution system. The power wire 1202 interfaces with the photon stream source 1220 at a rear or side-mounted connector.

Additional data and control signals may be provided by wires bundled with the power wire 1202 by a wire harness 1208, routed alongside the power wire 1202. The wire harness 1208 may bundle lines for stepper motor control, emitter activation commands, thermal sensor feedback, or diagnostic telemetry. In some implementations, the power wire 1202 and wire harness 1208 may be bundled into a single integrated harness.

The arrangement of FIG. 12 supports modular installation and replacement of the photonic propulsion subsystem. The combination of mounting brackets 1210, fasteners 1200, and accessible wiring pathways enables serviceability, reconfiguration, or positioning of multiple photon stream sources around the spacecraft 1240 to enable multi-axis thrust generation.

Although FIG. 12 illustrates a single rotator arm 1206 and single stepper motor 1204, alternative implementations may employ dual-axis gimbals, flexure-based positioning mechanisms, or hybrid steering systems combining mechanical and optical adjustments.

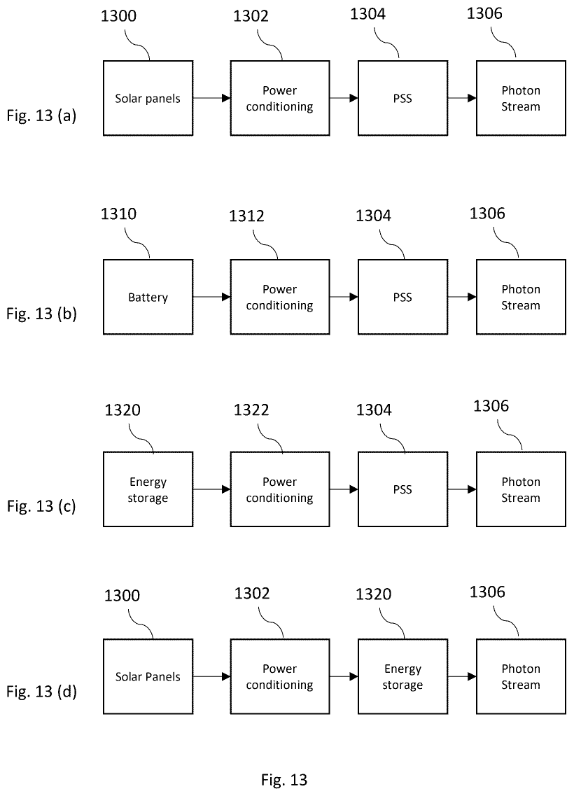

FIGS. 13(a)-13(d) illustrate example electrical power architectures for supplying energy to the photon stream source 1304 and generating the photon stream (beam) 1306. These diagrams demonstrate that the photonic propulsion system may interface with multiple types of spacecraft electrical subsystems, including solar arrays, batteries, capacitors, or hybrid storage devices.

FIG. 13(a) illustrates an implementation in which electrical power is supplied primarily by a solar panels module 1300. The solar panels convert incident solar radiation into direct current electrical power.

The output from the solar panels module 1300 is routed to a solar panels power conditioning module 1302, which regulates the voltage, current, and power quality. Conditioning functions may include maximum power point tracking (MPPT), step-up or step-down DC/DC conversion, filtering, and load balancing.

The conditioned power is then delivered to the photon stream source 1304 (PSS), which energizes the solid-state emitters to generate optical output. The emitted directed photon beam is represented schematically as the photon stream 1306.

FIG. 13(b) illustrates an implementation in which power is drawn from a battery module 1310. The battery module may consist of lithium-ion cells, nickel-hydride cells, or other aerospace-grade rechargeable batteries.

The battery output is routed to a battery power conditioning module 1312, which regulates discharge current, voltage levels, and protects against overcurrent and undervoltage conditions.

The conditioned battery power is supplied to the photon stream source 1304, which produces the photon stream 1306. This configuration allows the photonic propulsion system to operate during eclipse, low-power solar states, or high-demand scenarios requiring short-duration, high-power pulses. Accordingly, the power subsystem may access stored electrical power from a battery module 1310 or energy storage device and provide the stored electrical power to the photon stream source 1304 for energizing the solid-state emitters.

FIG. 13(c) illustrates a configuration using an energy storage module 1320, which may include supercapacitors, ultracapacitors, flywheels, rechargeable capacitive arrays, or hybrid storage elements combining battery-like and capacitor-like characteristics.

The energy storage module supplies power to an energy storage power conditioning module 1322, which performs voltage regulation, charge balancing, pulse shaping, or high-current switching required for burst-mode thrust.

The conditioned energy is delivered to the photon stream source 1304, which generates the photon stream 1306. This architecture is particularly well suited for delivering high instantaneous electrical power for burst thrust operations.

FIG. 13(d) illustrates a hybrid configuration combining a solar panels module 1300, a solar panels power conditioning module 1302, an energy storage module 1320, and the photon stream source 1304.

In this implementation, the solar panels module 1300 feed regulated power through the solar panels power conditioning module 1302. Surplus energy may be stored in the energy storage module 1320, which provides additional power buffering, peak power capability, and eclipse tolerance.

The energy storage module 1320 directly supplies or supplements energy to the photon stream source 1304, which in turn generates the photon stream 1306. This architecture offers operational flexibility and supports continuous, pulsed, and burst-mode thrust while maintaining overall spacecraft power stability.

In other implementations, the power subsystem may selectively draw electrical power from the solar-derived power input, the energy storage device, or a combination thereof to energize the solid-state emitters. In some implementations, the power subsystem receives electrical power from the spacecraft's power bus or other spacecraft power source, conditions the received electrical power, and supplies the conditioned electrical power to the photon stream source.

The architectures shown in FIGS. 13(a)-13(d) are illustrative. Any combination of solar arrays, batteries, capacitors, regenerative fuel cells, or other energy sources may be used to power the photonic propulsion system. Additional power conditioning stages may be included to support multiple photon stream sources operating concurrently.

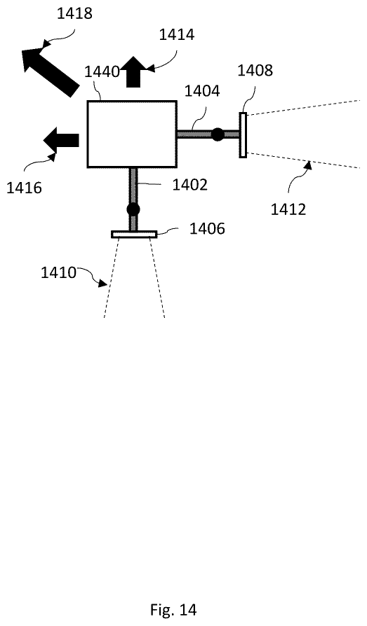

FIG. 14 illustrates an implementation of a multi-module photonic propulsion configuration in which two independently steerable photon stream sources generate separate thrust vectors that combine to form a resultant thrust vector applied to the spacecraft. This arrangement enables multi-axis control authority, torque generation, and fine-resolution thrust vectoring without requiring mechanical rotation of the spacecraft body.

As shown in FIG. 14, the spacecraft 1440 supports rotator arm 1 (1402) and rotator arm 2 (1404). These rotator arms provide mechanical positioning for two separate photon stream sources. Each arm may incorporate joints, actuators, or stepper-motor-based positioning mechanisms to orient the attached photon stream sources.

A first photon stream source, labeled photon stream source 1 (1406), is mounted at the distal end of rotator arm 1 (1402). During operation, photon stream source 1 emits a directed photon stream 1 (1410), represented by dashed lines extending from the source. The momentum carried by photon stream 1 generates a partial thrust vector 1 (1414) acting on the spacecraft 1440.

A second photon stream source, labeled photon stream source 2 (1408), is mounted at the distal end of rotator arm 2 (1404). Photon stream source 2 emits a directed photon stream 2 (1412), producing a partial thrust vector 2 (1416). In the illustrated implementation, photon stream source 2 is oriented laterally relative to the spacecraft body, producing a thrust component different from that generated by photon stream source 1.

The two partial thrust vectors 1414 and 1416 sum vectorially to create a combined thrust vector 1418, which represents the net reaction force imparted to the spacecraft 1440. The combined thrust vector 1418 may have both translational and rotational effects depending on the magnitude and orientation of the partial thrust vectors.

By independently controlling the orientation and power level of photon stream sources 1406 and 1408—through actuation of rotator arms 1402 and 1404 or internal optical steering—the system can achieve fine directional control of the combined thrust vector 1418. This enables maneuvers such as pitch, yaw, and roll control, as well as lateral and axial thrusting, without reliance on propellant-based thrusters or reaction wheels.

Although FIG. 14 illustrates two photon stream sources for clarity, the system encompasses configurations employing three, four, or more photonic propulsion modules distributed around the spacecraft body to provide fully omnidirectional thrust authority, redundancy, or enhanced torque generation.

FIG. 15 depicts a flowchart illustrating a method 1500 for generating thrust for a spacecraft using a photonic propulsion system. The method 1500 may be performed by processing logic of a photonic propulsion system.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

At step 1510, using electrical power provided by a power subsystem, a plurality of solid-state photon emitters of a photon stream source are energized to emit electromagnetic radiation.

At step 1520 at least a portion of the emitted electromagnetic radiation are collimated using an optical collimation assembly to form a collimated photon beam having a reduced spatial divergence relative to the emitted electromagnetic radiation.

At step 1530 the collimated photon beam is oriented using a pointing subsystem in a commanded direction.

At step 1540 a control subsystem controls, in response to a thrust command received via a spacecraft avionics interface, activation of the solid-state emitters and operation of the pointing subsystem to generate a thrust vector for the spacecraft using momentum carried by the collimated photon beam.

At step 1560, a spacecraft avionics interface establishes communication between the photonic propulsion system and the spacecraft.

In an implementation, in response to the control subsystem receiving a thrust request, the following steps are performed. These steps are explained in detail with regard to FIG. 9. The beam orientation computation is performed. An emitter activation pattern is computed. A power availability is checked. Thermal constraints are checked. The solid-state emitters and pointing subsystem are driven. Feedback is received from spacecraft avionics interface. Completion of a thrust maneuver is evaluated.

In an implementation, it is then determined whether the thrust maneuver is completed, as detailed in block 916 of FIG. 9.

In an implementation, emitter drive levels are modulated to produce continuous, pulsed, or burst thrust profiles.

In an implementation, orienting the photon beam comprises mechanically rotating the photon stream source.

In an implementation, orienting the photon beam comprises steering the beam using a MEMS-actuated mirror.

In an implementation, feedback is received from spacecraft sensors and adjusting emitter activation or beam orientation in response

The implementations described herein provide a practical, electrically powered photonic propulsion system capable of generating thrust and torque for spacecraft without the need for consumable propellants. The disclosed system integrates solid-state emitters, optical collimation elements, mechanical and optical pointing mechanisms, power conditioning electronics, thermal management structures, and control algorithms into a unified propulsion architecture. Variations are presented for emitter arrays, lens systems, beam-steering mechanisms, power sources, thermal pathways, and multi-module configurations, illustrating that the system may be adapted for spacecraft of different sizes, mission types, and maneuvering requirements.

The elements and components illustrated in the figures are not limited to the specific arrangements shown. Elements identified in one figure may correspond to elements in other figures, even though the elements may be assigned different reference numerals. Any feature described with respect to one implementation may be combined with features of any other implementation and reference numerals are used for identification and explanation. Similar elements with different reference numerals in different figures may provide similar functionality. The detailed descriptions of figures, subsystems, and operational modes illustrate specific examples of how the system may be implemented. These implementations are not intended to limit the invention but rather to provide a foundation enabling a wide range of modifications, equivalents, and enhancements. Any suitable combination of emitter technologies, optical components, mechanical actuation, cooling systems, energy sources, and control strategies may be employed to achieve directed photon emission for propulsion.

The present system offers many benefits over existing systems. For example, the present system differs fundamentally from the classical “photon rocket” concept, which describes only a theoretical relation between emitted optical power and thrust and does not provide any practical means for generating, shaping, steering, powering, cooling, or controlling the emitted photons. The present system instead provides a complete engineered implementation including solid-state emitter arrays, optical collimation assemblies to reduce divergence and maximize thrust, mechanical or optical pointing mechanisms for thrust vectoring, integrated power and thermal subsystems, and a closed-loop control architecture. These elements collectively enable practical, sustained spacecraft propulsion using onboard photon emission, which has not been previously taught or enabled.

The system also differs from known external-beam “photonic thruster” systems that rely on two spacecrafts, where one spacecraft generates a high-power laser beam and the other reflects it to produce thrust through multi-pass photon amplification. In contrast, the present system is a self-contained, single-spacecraft propulsion module in which all photon generation, collimation, and steering occur onboard the spacecraft. No external beam source, reflectance-based amplification, formation flying, or optical cavity between spacecraft is required. Thrust and torque are instead produced directly from onboard emission, enabling independent maneuvering, distributed multi-module operation, and propellant-free attitude and trajectory control.

The system further differs from light-sail propulsion concepts, which rely on external photon pressure applied to a large-area reflective membrane or sail. Light-sail systems use illumination from a remote source—such as a star or a ground- or space-based laser—and produce thrust by reflecting or absorbing incident photons over a large surface area. In contrast, the present propulsion system generates thrust internally by emitting photons directly from onboard solid-state emitters, without the need for a reflective sail, external illumination, or large deployed structures. The present system provides compact, electrically powered propulsion modules capable of fine thrust vectoring, torque generation, and multi-module coordination, enabling maneuverability and attitude control that light-sail architectures cannot achieve.

The invention encompasses all variations that achieve the functional objectives described herein, including single-module propulsion systems, multi-module distributed architectures, hybrid mechanical-optical pointing systems, and alternative optical layouts for beam formation and steering. Future improvements in emitter efficiency, optical materials, energy storage, and spacecraft avionics may be incorporated without departing from the scope and spirit of the invention.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “of” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

### Glossary

100—Photon Stream Source
102—Optical Collimation Assembly
104—Pointing Subsystem
110—Spacecraft
120—Thrust Vector
122—Directed Photon Beam
150—Photonic Space Propulsion System
200—Photonic Space Propulsion System Block
210—Photon Stream Source
212—Optical Collimation Assembly
214—Pointing Subsystem
216—Power Subsystem
218—Thermal Management Subsystem
220—Photonic Propulsion Control System
222—Spacecraft Avionics Interface
224—Control System Bus
226—Power Subsystem Bus
300—Photon Stream Source
330—Solid-State Emitters
332—Supporting Substrate
334—Electrical Interconnects
400—Photon Stream Source
402—Optical Collimation Assembly
430—Emitter Modules
432—Supporting Substrate
440—Lens Substrate
442—Micro Lens
445—Divergent Rays
447—Collimated Beam
500—Photon Stream Source
510—Spacecraft
520—Photonic Space Propulsion System
550—Stepper Motor
552—Rotator Arm
600—Mirror
602—Mirror Base
604—MEMS Actuators
606—Set of Reflected Beams
630—Emitters
632—Supporting Substrate
640—Lens Substrate
642—Microlenses
645—Divergent Rays
647—Collimated Beam
700—Heat Spreader
702—Coolant Loops
704—Radiator
730—Emitters
732—Supporting Substrate
800—Steady Thrust Profile
810—Pulsing Thrust Profile
820—Burst Thrust Profile
1030—Emitters
1032A—Rectangular Substrate
1032B—Circular Substrate
1032C—Polygonal Substrate
1100—Macro Lens
1130—Emitters
1132—Supporting Substrate
1145—Divergent Rays
1147—Collimated Beam
1200—Fasteners
1202—Power Wire
1204—Stepper Motor
1206—Rotator Arm
1208—Wire Harness
1210—Mounting Bracket
1220—Photon Stream Source
1240—Spacecraft
1300—Solar Panels Module
1302—Solar Panels Power Conditioning Module
1304—Photon Stream Source
1306—Photon Stream (Beam)
1310—Battery Module
1312—Battery Power Conditioning Module
1320—Energy Storage Module
1322—Energy Storage Power Conditioning Module
1402—Rotator Arm 1
1404—Rotator Arm 2
1406—Photon Stream Source 1
1408—Photon Stream Source 2
1410—Photon Stream 1
1412—Photon Stream 2
1414—Partial Thrust Vector 1
1416—Partial Thrust Vector 2
1418—Combined Thrust Vector
1440—Spacecraft

What is claimed is:

1. A photonic propulsion system for a spacecraft, comprising:
a photon stream source comprising a plurality of solid-state emitters mounted on a substrate and configured to emit electromagnetic radiation in response to being activated;
an optical collimation assembly positioned in optical alignment with the photon stream source and configured to receive the electromagnetic radiation from the solid-state emitters and further configured to convert at least a portion of the electromagnetic radiation to a collimated photon beam comprising a reduced spatial divergence relative to the emitted optical radiation;
a pointing subsystem configured to orient the collimated photon beam in a commanded direction;
a power subsystem configured to provide electrical power to the photon stream source to energize the solid-state emitters;
a thermal management subsystem thermally coupled to the photon stream source and configured to dissipate heat generated during operation of the solid-state emitters and other heat generating components of the photonic propulsion system;
a spacecraft avionics interface configured to enable communication between the photonic propulsion system and the spacecraft; and
a control subsystem configured to:
receive, from the spacecraft avionics interface, a thrust command;
in response to receiving the thrust command, regulate activation of the solid-state emitters using the electrical power provided by the power subsystem; and
regulate operation of the pointing subsystem to generate a thrust vector for the spacecraft using momentum carried by the collimated photon beam.

2. The photonic propulsion system of claim 1, wherein the power subsystem is configured to access stored electrical power and provide the stored electrical power to the photon stream source to energize the solid-state emitters.

3. The photonic propulsion system of claim 1, wherein the power subsystem is configured to receive the electrical power from a spacecraft power source, condition received electrical power, and provide the received electrical power to the photon stream source.

4. The photonic propulsion system of claim 1, wherein the power subsystem comprises at least one of a solar-derived power input or an energy storage device, and wherein the power subsystem is configured to selectively draw power from the solar-derived power input or the energy storage device to energize the solid-state emitters.

5. The photonic propulsion system of claim 1, wherein the solid-state emitters comprise at least one of light-emitting diodes (LEDs), laser diodes, or vertical-cavity surface-emitting lasers (VCSELs).

6. The photonic propulsion system of claim 1, wherein the emitters are arranged in a planar, circular, polygonal, curved, or faceted array.

7. The photonic propulsion system of claim 1, wherein the optical collimation assembly comprises a microlens array which collimates spatially divergent electromagnetic radiation from the plurality of solid-state emitters.

8. The photonic propulsion system of claim 1, wherein the optical collimation assembly comprises a macro lens which collimates spatially divergent electromagnetic radiation from the plurality of solid-state emitters.

9. The photonic propulsion system of claim 1, wherein the pointing subsystem comprises a mechanical actuator comprising stepper motors, servomotors, gimbals, or rotator arms.

10. The photonic propulsion system of claim 1, wherein the pointing subsystem comprises an optical steering mechanism comprising a mirror actuated by micro-electromechanical (MEMS) actuators.

11. The photonic propulsion system of claim 1, wherein the thermal management subsystem comprises a heat spreader thermally coupled to the plurality of solid-state emitters, coolant loops configured to remove heat from the heat spreader, and a radiator configured to dissipate heat into space, wherein the radiator is thermally coupled to the coolant loops.

12. The photonic propulsion system of claim 1, wherein the control subsystem uses feedback from spacecraft avionics to adjust emitter activation or beam orientation.

13. The photonic propulsion system of claim 1, wherein a plurality of photonic propulsion system modules are positioned asymmetrically around a body of the spacecraft to generate torque.

14. The photonic propulsion system of claim 13, wherein at least one of the plurality of photonic propulsion system modules is mounted on a rotatable arm configured to vary the thrust vector relative to a center of mass of the spacecraft.

15. A method of generating thrust for a spacecraft using a photonic propulsion system, the method comprising:
energizing, using electrical power provided by a power subsystem, a plurality of solid-state photon emitters of a photon stream source to emit electromagnetic radiation;
collimating at least a portion of the emitted electromagnetic radiation using an optical collimation assembly to form a collimated photon beam having a reduced spatial divergence relative to the emitted electromagnetic radiation;
orienting the collimated photon beam using a pointing subsystem in a commanded direction;
controlling, by a control subsystem, in response to a thrust command received via a spacecraft avionics interface, activation of the solid-state emitters and operation of the pointing subsystem to generate a thrust vector for the spacecraft using momentum carried by the collimated photon beam; and
establishing communication, by a spacecraft avionics interface, between the photonic propulsion system and the spacecraft.

16. The method of claim 15, further comprising modulating emitter drive levels to produce continuous, pulsed, or burst thrust profiles.

17. The method of claim 15, wherein orienting the photon beam comprises mechanically rotating the photon stream source.

18. The method of claim 15, wherein orienting the photon beam comprises steering the beam using a MEMS-actuated mirror.

19. The method of claim 15, further comprising receiving feedback from the spacecraft avionics interface and adjusting emitter activation or beam orientation in response to the feedback.

20. The method of claim 15, further comprising, in response to the control subsystem receiving a thrust request:
performing beam orientation computation;
computing an emitter activation pattern;
checking a power availability;
checking thermal constraints;
driving the plurality of solid-state emitters and pointing subsystem;
receiving feedback from spacecraft avionics interface; and
evaluating completion of a thrust maneuver.
